(19) United States
(12) Patent Application Publication
(10) Pub. No.: US 2015/0308333 A1
(43) Pub. Date: Oct. 29, 2015

(54) ANCILLARY DEVICE FOR ENHANCING ENERGY SAVING AND CARBON REDUCTION EFFICIENCY OF ENGINE

(71) Applicant: Wen Lo Chen, Taipei City (TW)

(72) Inventor: Wen Lo Chen, Taipei City (TW)

(21) Appl. No.: 14/260,286

(22) Filed: Apr. 24, 2014

(51) Int. Cl. F02B 43/10

(52) U.S. Cl. CPC F02B 43/10; F02B 2043/106

(57) ABSTRACT

An ancillary device is provided for enhancing energy saving and carbon reduction efficiency of an engine and includes an electrolytic bath mounted in an automobile to receive a supply of pure water. The electrolytic bath is electrically connected to an automobile battery, such that when the battery supplies an electrical current to the electrolytic bath, the electrolytic bath electrolyzes the pure water supplied thereto into hydrogen and oxygen, which are respectively conveyed through the first gas conveyance tube and the second gas conveyance tube into an intake manifold of the engine and a fuel pipe to allow hydrogen, after being mixed with fuel, to be supplied into a cylinder of the engine for combustion, while oxygen is fed through the intake manifold into the cylinder of the engine to support the combustion.

### TECHNICAL FIELD OF THE INVENTION

The present invention generally relates to an ancillary device that generates a secondary fuel that is added into a primary fuel supply system of a vehicle to be supplied together to an engine cylinder so as to reduce the original consumption of fuel, enhance fuel combustion efficiency, and achieve an effect of energy saving and carbon reduction.

### DESCRIPTION OF THE PRIOR ART

A conventional gasoline engine or diesel engine, when put into operation, emits exhaust gases, causing severe air pollution and leading to the global warming effect. In a combustion process of a diesel engine, various sorts of gaseous, liquid, and solid pollutants are generated and gaseous contaminants, such as carbon oxide (CO), sulfur oxides (SOₓ), carbon dioxide (CO₂), and hydrocarbons (HC), are also generated, causing global ecological environment disruption issues, such as damaging the ozone layer, causing acidic rains, and increasing greenhouse effect and also causing potential healthy risks of human bodies. For example, nitrogen oxides may be converted into nitric acid, which causes acidic rains and damages the ozone layer and generates photochemical smog when acting with sun light. Particle pollutants or soot may contain polycyclic aromatic hydrocarbons (PAHs) or metal compounds that lead to pathological changes of lungs, tracheas, and respiratory tracts. Pollutants generated by a gasoline engine are not as much as those of the diesel engine, but there is still emission of toxicant substances, such as hydrocarbons, which may cause certain threat to human health and the environment.

Various solutions have been proposed in the motor vehicle industry. For example, a filtration system is included in an exhaust pipe of a vehicle engine to filter a mass emission of exhaust gases from the vehicle engine. However, this does not completely resolve the environmental protection issue that vehicles must consume a great deal of fossil fuel. As another example, electrical vehicles, hybrid vehicle, or solar vehicles are under development in the automobile industry; however, due to no significant breakthrough of the battery technology, problems such as storage capacity, charging speed, excessive weight of the battery have not yet been overcome. Thus, the costs of the electrical vehicles, hybrid vehicles, and solar vehicle remain very high, making it not possible for them to get popularized.

For the conventional diesel engines and gasoline engines, the consumption efficiency of fuel is around 15% to 28%. The incomplete combustion of fuel generates, almost every in the world, toxicant waste gases, such as soot (CO), suspension particles (PM2.5-PM10), hydrocarbons (HC), nitrogen oxides (NOₓ), and bad smell gases. They affect the health of residents and also lead to warming of the Earth and abrupt change of climate.

### SUMMARY OF THE INVENTION

An object of the present invention is to resolve the problem that the fuel combustion efficiency of an existing vehicle cannot be improved with a simple way so that the exhaust gases emitting after the combustion contains a high content of pollutant ingredients, making it easy to generate smokes and not allowing for reduction of fuel consumption.

The present invention is characterized in that a device that is mounted in an automobile to supply, in a proper manner, hydrogen and oxygen that serve as ancillary fuel. Hydrogen is supplied to a fuel pipe to be supplied with fuel into a combustion chamber of a cylinder of an engine for combustion and oxygen is supplied into an intake manifold for properly mixing with air to be supplied into the engine to support the combustion. By increasing the contents of oxygen and hydrogen in the fuel, at the moment of timed ignition, the mixed gas of hydrogen and oxygen and the fuel can be instantaneously and fast ignited so as to enhance the combustion efficiency of the fuel, improve driving power, and reduce all sorts of toxicant waste gases and bad smells, namely desired combustion performance and power being obtained through a reduced consumption of fuel, thereby accomplishing an effect of reducing the consumption of fuel and saving fuel costs.

A technical solution adopted in the present invention is that an electrolytic bath is mounted in an automobile to receive a supply of pure water. The electrolytic bath is electrically connected to an electrical power supply of the automobile. The electrolytic bath is connected to a first gas conveyance tube and a second gas conveyance tube. The second gas conveyance tube is connected to a fuel pipe of the automobile. When fed with an electrical current, the electrolytic bath electrolyzes the pure water supplied thereto into hydrogen and oxygen. The oxygen is supplied through the first gas conveyance tube into the intake manifold to be properly mixed with air for being introduced into a cylinder of the engine and the hydrogen is supplied through the second gas conveyance tube into the fuel pipe to be properly mixed with fuel and subsequently supplied with the fuel into the cylinder of the engine for combustion thereby achieving the purposes of saving energy and saving fuel and also accomplishing an effect of reducing contamination, eliminating bad smells, reducing carbon, and disinfection.

Another technical solution adopted in the present invention is that an electrolytic bath is connected to a first gas conveyance tube and a second gas conveyance tube. The first gas conveyance tube and the second gas conveyance tube are both connected to an intake manifold of an engine. After being fed with an electrical current, the electrolytic bath electrolyzes pure water into hydrogen and oxygen. The oxygen and the hydrogen are respectively supplied through the first gas conveyance tube and the second gas conveyance tube into the intake manifold to be properly mixed with air and then introduced into a cylinder of the engine for combustion.

The present invention is operable to continuously supply pure oxygen gas into the intake manifold to immediately and fast increase the oxygen content of the intake air and simultaneously reduce the nitrogen content of the intake air. The air with increased oxygen and decreased nitrogen, when introduced into the cylinder for combustion, can immediately increase the combustion efficiency of the engine and enhance power so as to achieve an effect of saving fuel and also help remove carbon deposit from the cylinder to thereby reduce the generation of soot and toxicant gases, such as PAHs, HC, and CO, resulting from incomplete combustion and contaminant suspension particles of PM2.5 and PM 10. Further, due to the reduction of nitrogen content, reduction of the formation of nitrogen oxides (NOₓ) can also be achieved to protect the atmosphere from continuous damages caused by photochemical pollution.

While continuously supplying pure hydrogen gas into the fuel pipe, the present invention increases the hydrogen content of the fuel so that when fed into a cylinder for combustion, they increase the combustion efficiency of the engine and enhance power so as to achieve an effect of saving fuel and also help remove carbon deposit from the cylinder to thereby reduce the generation of soot and toxicant gases, such as PAHs, HC, and CO, resulting from incomplete combustion and contaminant suspension particles of PM2.5 and PM 10. Further, due to the reduction of nitrogen content, reduction of the formation of nitrogen oxides (NOₓ) can also be achieved to protect the atmosphere from continuous damages caused by photochemical pollution.

The ancillary device of the present invention is controlled by an automobile computer so as to automatically activate or deactivate the electrolytic bath at the time when the electrical power supply of the automobile is turned on or off. The electrolytic bath, when activated, automatically regulates the voltage and the magnitude of direct current in order to control the rate of hydrogen and oxygen generated by electrolysis.

In performing electrolysis of pure water, the ancillary device of the present invention needs only to control, in a stable manner, the voltage and current in order to achieve control of the generation rate of hydrogen and oxygen for continuous feed into the fuel pipe and the intake manifold through negative pressure means (siphon effect). The hydrogen, after mixed with fuel, is supplied collectively into a combustion chamber of the engine to be ignited therein, while the oxygen is mixed with air in an intake manifold to be then supplied into the combustion chamber of the engine to support the combustion for achieving better combustion efficiency.

The present invention comprises throttle valves respectively mounted to the first gas conveyance tube and the second gas conveyance tube so that when the electrical power supply is shut down, the throttle valves are automatically closed to stop output of hydrogen and oxygen and when the electrical power supply is turned on, the throttle valves are automatically opened to output hydrogen and oxygen.

The present invention employs electrolysis of water to supply separate flows of pure hydrogen gas and pure oxygen gas to prevent, on the one hand, the generation of gas blowing and the risk of blow back when hydrogen and oxygen are mixed with equal ratio. Further, due to being combined with the electricity of an automobile, when the automobile is shut down, the operation of electrolysis stops simultaneously so that there is no risk resulting from storage of hydrogen or oxygen. Thus, the present invention can be regarded as a fuel-saving and pollution-eliminating device that is most economic, practical, safe, and effective.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a first embodiment of the present invention applied to a fuel supply system of an automobile.

FIG. 2 is a schematic view showing a second embodiment of the present invention applied to a fuel supply system of an automobile.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

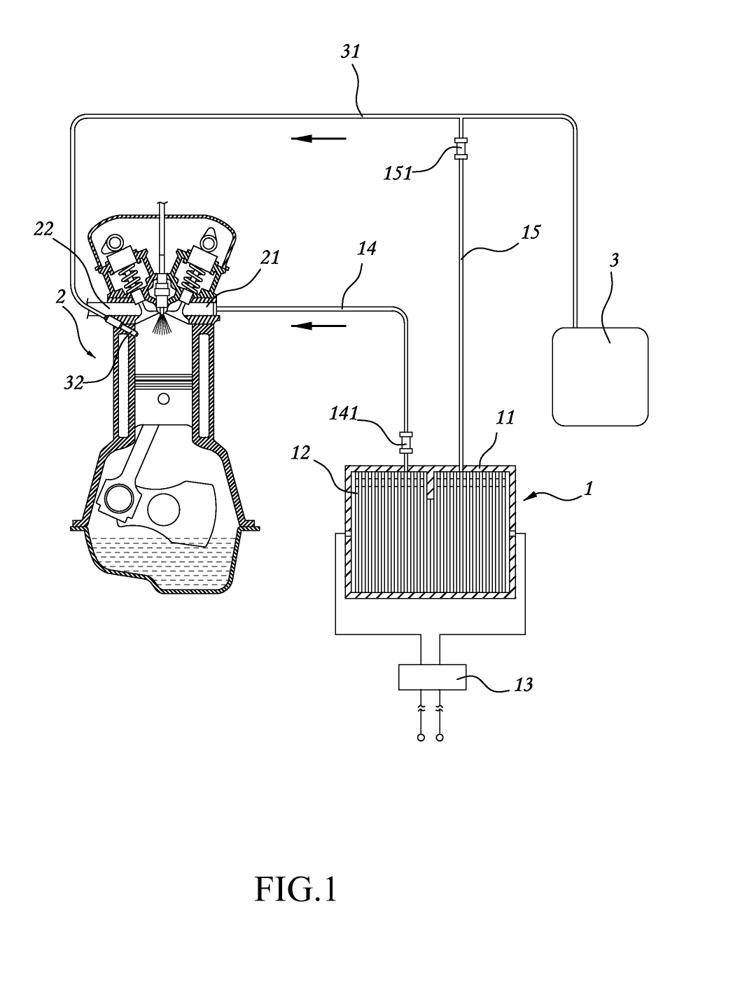

FIG. 1 is a schematic view showing an ancillary device according to a first embodiment of the present invention that is applied to an automobile fuel supply system and is characterized in that an electrolytic bath 1 is arranged at a proper location in an automobile. The electrolytic bath 1 comprises a tank 11 in which a plurality of plates 12 is arranged to provide a chemical reaction for inducing electrolysis. The electrolytic bath 1 is electrically connected, via a transformer 13 to a battery that is provided in the automobile. A regular battery provided for an automobile generally has a voltage of 12V (volts), and the voltage is down-converted by the transformer 13 to 6V (volts) to be then supplied to the electrolytic bath 1 for activating the chemical electrolysis reaction. The present invention provides at least one first gas conveyance tube 14 and at least one second gas conveyance tube 15 connected to the tank 11. The first gas conveyance tube 14 is also connected to an intake manifold 21 of a cylinder of an engine 2 of the automobile. The second gas conveyance tube 15 is connected to a fuel pipe 31, such as a liquid fuel pipe or a gaseous fuel pipe. The first gas conveyance tube 14 and the second gas conveyance tube 15 are respectively provided with a first throttle valve 141 and a second throttle valve 151. The fuel pipe 31 is connected a fuel tank 3 and a fuel injection nozzle 32 mounted to the engine 2. The present invention is operated in such a way that when the electrical power supply is shut off, the first throttle valve 141 and the second throttle valve 151 are automatically closed to cut off output of oxygen and hydrogen and when the electrical power supply is turned on, the first throttle valve 141 and the second throttle valve 151 are automatically opened to output oxygen and hydrogen.

The present invention is controlled by an automobile computer to automatically supply or cut off electrical power fed to the electrolytic bath 1 at the time when the electrical power supply of the automobile is turned on or off. The electrolytic bath 1, when activated, automatically regulates the voltage and the magnitude of direct current in order to control the rate of hydrogen and oxygen generated by electrolysis. In performing electrolysis of pure water, the ancillary device of the present invention needs only to control, in a stable manner, the voltage and current in order to achieve control of the generation rate of hydrogen and oxygen, wherein hydrogen is continuously fed into the fuel pipe 31 through negative pressure means (siphon effect) so as to mix with the fuel and then be introduced through the fuel injection nozzle 32 into a combustion chamber of the cylinder of the engine 2 for combustion therein, while oxygen is supplied into the intake manifold 21 to be mixed with air to be introduced through a valve into the combustion chamber of the engine 2 for being ignited therein. The waste gases generated by the combustion are conveyed through another valve to be exhausted through an exhaust manifold 22. For automobiles, hydrogen can be instantaneously ignited in around one tenth seconds; this, together with combustion supporting effect provided by oxygen, allows for achievement of better combustion efficiency for the hydrogen-fuel mixture gas in the combustion chamber of the cylinder, improvement of driving power, and reduction of all sorts of toxicant waste gases and bad smells, namely desired combustion performance and power being obtained through a reduced consumption of fuel, so as to accomplish an effect of reducing the consumption of fuel and saving fuel costs.

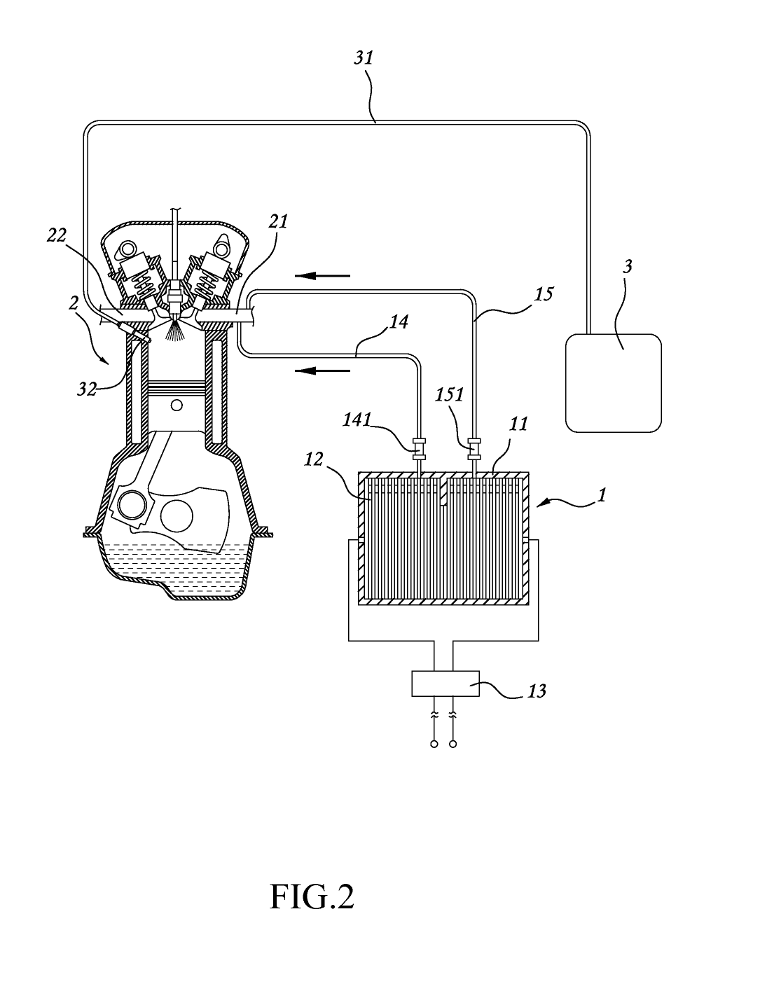

FIG. 2 is a schematic view showing an ancillary device according to a second embodiment of the present invention that is applied to an automobile fuel supply system and similarly comprises an electrolytic bath 1 arranged at a proper location in an automobile. The electrolytic bath 1 comprises a tank 11 in which a plurality of plates 12 is arranged to provide a chemical reaction for inducing electrolysis. The electrolytic bath 1 is electrically connected, via a transformer 13 to a battery that is provided in the automobile. The present invention provides at least one first gas conveyance tube 14 and at least one second gas conveyance tube 15 connected to the tank 11. The first gas conveyance tube 14 and the second gas conveyance tube 15 are also connected to an intake manifold 21 of a cylinder of an engine 2 of the automobile. The first gas conveyance tube 14 and the second gas conveyance tube 15 are respectively provided with a first throttle valve 141 and a second throttle valve 151. A fuel pipe 31 is connected a fuel tank 3 and a fuel injection nozzle 32 mounted to the engine 2. The present invention is operated in such a way that when the electrical power supply is shut off, the first throttle valve 141 and the second throttle valve 151 are automatically closed to cut off output of oxygen and hydrogen and when the electrical power supply is turned on, the first throttle valve 141 and the second throttle valve 151 are automatically opened to output oxygen and hydrogen.

The present invention is controlled by an automobile computer to automatically supply or cut off electrical power fed to the electrolytic bath 1 at the time when the electrical power supply of the automobile is turned on or off The electrolytic bath 1, when activated, automatically regulates the voltage and the magnitude of direct current in order to control the rate of hydrogen and oxygen generated by electrolysis. In performing electrolysis of pure water, the ancillary device of the present invention needs only to control, in a stable manner, the voltage and current in order to achieve control of the generation rate of hydrogen and oxygen, wherein hydrogen and oxygen are continuously fed into the intake manifold 21 to be mixed with air for being subsequently introduced through a valve into a combustion chamber of the engine 2 for being ignited therein. The waste gases generated by the combustion are conveyed through another valve to be exhausted through an exhaust manifold 22.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An ancillary device for enhancing energy saving and carbon reduction efficiency of an engine, comprising an electrolytic bath adapted to receive pure water supplied thereto, the electrolytic bath being connected with a first gas conveyance tube and a second gas conveyance tube, the first gas conveyance tube being connected to an intake manifold of an engine, the second gas conveyance tube being connected to a fuel pipe, the fuel pipe being connected to the engine and a fuel tank, wherein when fed with an electrical current, the electrolytic bath electrolyzes the pure water supplied thereto into hydrogen and oxygen, the oxygen being conveyed through the first gas conveyance tube to the intake manifold for being introduced into the engine, the hydrogen being conveyed through the second gas conveyance tube into the fuel pipe for being mixed with fuel and subsequently supplied with the fuel into the engine so as to have the hydrogen and the oxygen combusted in the engine with a predetermined ratio.

2. The ancillary device for enhancing energy saving and carbon reduction efficiency of an engine according to claim 1, wherein the first gas conveyance tube and the second gas conveyance tube respectively comprise at least one first throttle valve and a second throttle valve mounted thereto.

3. An ancillary device for enhancing energy saving and carbon reduction efficiency of an engine, comprising an electrolytic bath adapted to receive pure water supplied thereto, the electrolytic bath being connected with a first gas conveyance tube and a second gas conveyance tube, the first gas conveyance tube and the second gas conveyance tube being connected to an intake manifold of an engine, a fuel pipe that is in connection with a fuel tank being connected to the engine, wherein when fed with an electrical current, the electrolytic bath electrolyzes the pure water supplied thereto into hydrogen and oxygen, the oxygen and the hydrogen being respectively conveyed through the first gas conveyance tube and the second gas conveyance tube into the intake manifold and mixed with a predetermined ratio to be subsequently supplied into the engine for combustion.

4. The ancillary device for enhancing energy saving and carbon reduction efficiency of an engine according to claim 3, wherein the first gas conveyance tube and the second gas conveyance tube respectively comprise at least one first throttle valve and a second throttle valve mounted thereto.
